(19) United States
(12) Patent Application Publication
(10) Pub. No.: US 2024/0163231 A1
(43) Pub. Date: May 16, 2024

(54) ELECTRONIC APPARATUS AND CONTROL METHOD FOR MANAGING AVAILABLE POINTERS OF PACKET BUFFER

(71) Applicant: Realtek Semiconductor Corporation, Hsinchu (TW)

(72) Inventors: Ying-Sheng TSAI, Hsinchu (TW); Jen-Che TSAI, Hsinchu (TW); Shiao-Yang WU, Hsinchu (TW)

(21) Appl. No.: 18/481,222

(22) Filed: Oct. 4, 2023

(30) Foreign Application Priority Data
Nov. 15, 2022 (TW) 111143635

(51) Int. Cl. H04L 49/901; H04L 49/9005

(52) U.S. Cl. CPC H04L 49/901; H04L 49/9005

(57) ABSTRACT

An electronic apparatus includes a processing unit, a buffer memory and a buffer manager. The buffer memory includes some packet buffer slots. Each of the packet buffer slots aligns to a packet size. The buffer manager includes a cache for registering available pointers. Each of the available pointers is configured to mark a start address of one of the packet buffer slots. The buffer manager is configured to monitor an available pointer count of the available pointers. When the processing unit transmits an allocation request to the buffer manager and the available count is enough, the buffer manager obtains one available pointer from the cache and integrates the one available pointer and the available pointer count into an allocation response, which is sent to the processing unit.

### RELATED APPLICATIONS

This application claims the priority benefit of Taiwan Application Serial Number 111143635, filed Nov. 15, 2022, which is herein incorporated by reference.

### BACKGROUND

### Field of Invention

The disclosure relates to a control method and an electronic apparatus for managing buffers. More particularly, the disclosure relates to a control method and an electronic apparatus capable of managing available pointers of packet buffers.

### Description of Related Art

An electronic apparatus with a communication function usually includes a processor and a communication circuit. The processor is mainly responsible for data calculation tasks on the electronic apparatus, and the communication circuit is responsible for communication tasks with other external devices, such as receiving or transmitting packets from or to these external devices.

Usually, an inward packet received by the communication circuit can be temporarily stored in packet buffer storage, and the processor can read the inward packet at a specific address corresponding to the packet buffer storage. On the other hand, when the processor generates an outward packet to be transmitted to an external device, the processor can temporarily store the outward packet in the packet buffer storage. Then, the communication circuit reads the outward packet from a specific address corresponding to the packet buffer storage and transmits the outward packet to the external device.

Therefore, the electronic apparatus is required to manage allocations and returns of the packet buffer storage effectively. In one approach, a polling communication manner is utilized between the processor and the communication circuit to share a current usage status of the packet buffer storage. However, the polling communication manner will occupy a certain time period on a data bus connected between the processor and the communication circuit.

Another approach is utilizing a ready signal to indicate the current usage status of the packet buffer storage. For example, the ready signal is able to indicate whether the communication circuit finishes a previous packet transmission task or not. The processor has to wait until the ready signal (e.g., PREADY signal) is switched to a completion level, which indicates a finish of the previous packet transmission task. This approach based on the ready signal can be considered as a back-pressure type of flow control, and it is able to indicate the current usage status of the packet buffer storage. However, this approach is not able to predict an on-going flow rate, and it may lead to a head of line blocking problem. If a task takes a long time for a transmission, the ready signal will not be switched to the completion level in this case, and the processor is not able to read and write the packet buffer storage during this time period. It can be harmful to other parallel computations or tacks executed on the processor.

### SUMMARY

The disclosure provides an electronic apparatus, which includes a processing unit, a buffer memory and a buffer manager. The buffer memory has packet buffer spaces. Each of the packet buffer spaces is aligned to a packet size. The buffer manager includes a register for temporarily storing at least one available pointer. Each of the at least one available pointer is configured to mark a start address corresponding to one packet buffer space in the buffer memory. The buffer manager is configured to monitor an available pointer quantity and assign the at least one available pointer to the processing unit. In response to that the processing unit transmits a first allocation request to the buffer manager and the available pointer quantity is sufficient, the buffer manager is configured to obtain a first available pointer from the register, to update the available pointer quantity, to integrate the first available pointer and the available pointer quantity into a first allocation response, and to transmit the first allocation response to the processing unit.

The disclosure also provides an electronic apparatus, which includes a processing unit, a buffer memory and a buffer manager. The buffer memory has packet buffer spaces. Each of the packet buffer spaces is aligned to a packet size. The buffer manager includes a register for temporarily storing at least one available pointer. Each of the at least one available pointer is configured to mark a start address corresponding to one packet buffer space in the buffer memory. The buffer manager is configured to monitor an available pointer quantity and assign the at least one available pointer to the processing unit. The processing unit is configured to count a pending return pointer quantity, to integrate a first available pointer and the pending return pointer quantity into a return request, and to transmit the return request to the buffer manager. In response to that the buffer manager receives the return request, the buffer manager is configured to push the first available pointer into the register according to the return request and update the available pointer quantity.

The disclosure also provides a control method, include following steps. A first allocation request is sent from a processing unit to a buffer manager. Whether an available pointer quantity in a register is sufficient or not is determined by buffer manager. In response to that the available pointer quantity is sufficient, a first available pointer is obtained from the register by the buffer manager according to the first allocation request. The first available pointer is configured to mark a start address of a packet buffer space. The available pointer quantity within the register by the buffer manager is updated. The first available pointer and the available pointer quantity are integrated by the buffer manager for generating a first allocation response. The first allocation response is sent to the processing unit by the buffer manager.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a functional diagram illustrating an electronic apparatus according some embodiments of the disclosure.

FIG. 2 and FIG. 3 are flow chart diagrams illustrating a control method executed by the buffer manager for an assignment of the available pointer during that the processing unit generates the outward-transmitting packet and transmits the outward-transmitting packet through the communication transceiver unit.

FIG. 4 is a schematic diagram illustrating the integration between the first available pointer and the available pointer quantity into the first allocation response according to some embodiments of the disclosure.

FIG. 5 is a schematic diagram illustrating the integration between the first available pointer and the pending return pointer quantity into the first return request according to some embodiments of the disclosure.

FIG. 6 and FIG. 7 are flow chart diagrams illustrating a control method executed by the buffer manager for an assignment of the available pointer during that the communication transceiver unit receives the inward-transmitting packet and transmits the inward-transmitting packet to the processing unit.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

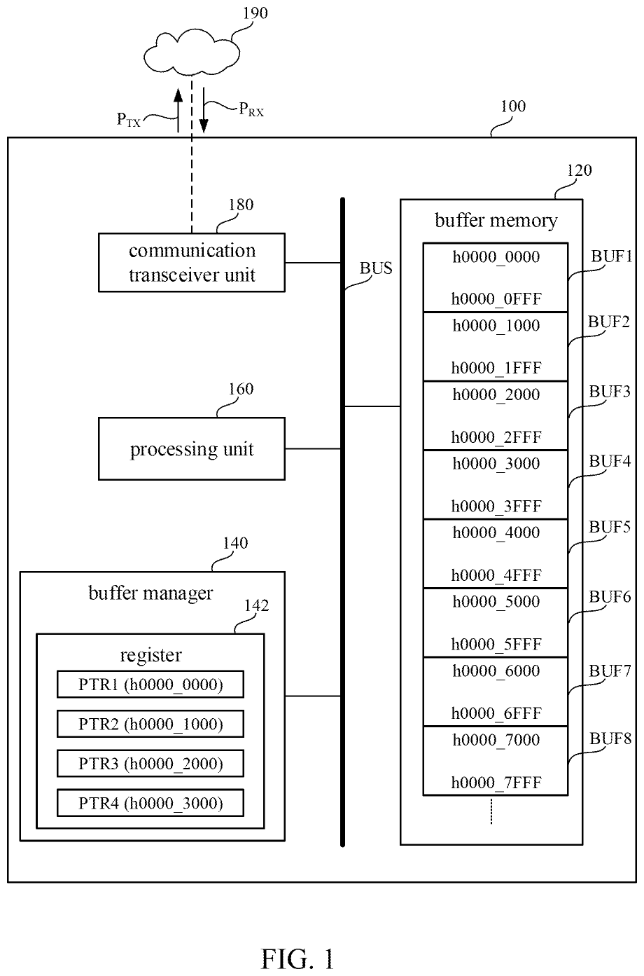

Reference is made to FIG. 1, which is a functional diagram illustrating an electronic apparatus 100 according some embodiments of the disclosure. As shown in FIG. 1, the electronic apparatus 100 include a buffer memory 120, a buffer manager 140, a processing unit 160 and a communication transceiver unit 180.

In an embodiment, the electronic apparatus 100 can be a computer, a smartphone, a network switch, a network gateway, a router or any equivalent device with communication functions. The electronic apparatus 100 is able to transmit an outward-transmitting packet P_{TX} to an external network 190 through the communication transceiver unit 180. On the other hand, the electronic apparatus 100 is able to receive an inward-transmitting packet P_{RX} from the external network 190 through the communication transceiver unit 180. Accordingly, the electronic apparatus 100 is able to exchange data with other devices over the external network 190 through the communication transceiver unit 180.

In an embodiment, the communication transceiver unit 180 may include an Ethernet transceiver circuit, a WiFi transceiver circuit, a Bluetooth transceiver circuit or any equivalent communication transceiver circuit. In another embodiment, the communication transceiver unit 180 may include a High Definition Multimedia Interface (HDMI) transmission circuit, a Digital Visual Interface (DVI) transmission circuit or any equivalent communication interface for transmitting image/video data.

In some embodiments, the communication transceiver unit 180 can be implemented by hardware circuits of aforesaid transceivers or communication interfaces. In some other embodiments, the communication transceiver unit 180 can be implemented by software instructions or firmware executed by logic circuits in a System on a Chip (SoC) integrated circuit.

The processing unit 160 of the electronic apparatus 100 is responsible for data computation tasks on the electronic apparatus 100. For example, the processing unit 160 can process user's audio input, generate a correspondingly audio packet and transmit the audio packet. On the other hand, the processing unit 160 can decode a received audio packet and play the received audio packet. In an embodiment, the processing unit 160 can be implemented by a processor, a central processing unit (CPU), a graphic processing unit (GPU), a tensor processing unit (TPU), an application-specific integrated circuit (ASIC) or any equivalent processing circuit.

In some embodiments, the processing unit 160 and the communication transceiver unit 180 may have different operating frequencies. The processing unit 160 usually has a relatively higher operating frequency to perform high-speed computations. Due to difference between the operating frequencies, the inward-transmitting packet P_{RX} received by the communication transceiver unit 180 is not suitable to be transmitted directly from the communication transceiver unit 180 to the processing unit 160. Similarly, the outward-transmitting packet P_{TX} generated by the processing unit 160 is not suitable to be transmitted directly from the processing unit 160 to the communication transceiver unit 180. In this embodiment, the outward-transmitting packet P_{TX} and the inward-transmitting packet P_{RX} will be temporarily stored in the buffer memory 120. The processing unit 160 and the communication transceiver unit 180 write or read the outward-transmitting packet P_{TX} and the inward-transmitting packet P_{RX} via the buffer memory 120.

As shown in FIG. 1, the buffer memory 120 includes several packet buffer spaces BUF1-BUF8. Each of the packet buffer spaces BUF1-BUF8 is capable of storing an outward-transmitting packet P_{TX} or an inward-transmitting packet P_{RX}. It is noticed that the buffer memory 120 may include more packet buffer spaces. For brevity, FIG. 1 illustratively shows the eight packet buffer spaces BUF1-BUF8 for demonstration and the disclosure is not limited to this amount of the packet buffer spaces.

In some embodiments, for convenience of data transmission, the outward-transmitting packet P_{TX} and the inward-transmitting packet P_{RX} have a fixed packet size. In this case, each of the packet buffer spaces BUF1-BUF8 in the buffer memory 120 has boundaries aligned with the fixed packet size, so as to elevate a space usage efficiency of the buffer memory 120.

In an embodiment shown in FIG. 1, the packet buffer space BUF1 is located between a start address h0000_0000 and an end address h0000_OFFF expressed in hexadecimal. The packet buffer space BUF2 is located between a start address h0000_1000 and an end address h0000_1FFF expressed in hexadecimal. Similarly, the packet buffer space BUF8 is located between a start address h0000_7000 and an end address h0000_7FFF expressed in hexadecimal.

In an embodiment, the buffer manager 140 is configured to manage the packet buffer spaces BUF1-BUF8 in the buffer memory 120, and assign these spaces to be utilized by the processing unit 160 and the communication transceiver unit 180. In some applications, the buffer manager 140 can be implemented by a free buffer manager (FBM) circuit, an application-specific integrated circuit (ASIC) or a microcontroller. In some other embodiments, the buffer manager 140 can be implemented by software instructions or firmware executed by logic circuits in a SoC integrated circuit.

In an embodiment, the buffer manager 140, the processing unit 160 and the communication transceiver unit 180 can be implemented by software instructions or firmware executed by logic circuits in the same SoC integrated circuit. In another embodiment, the buffer manager 140, the processing unit 160 and the communication transceiver unit 180 can be implemented by different hardware circuits (e.g., a SoC integrated circuit, a central processing unit and a network transceiver circuit).

In some embodiments, the buffer memory 120, the buffer manager 140, the processing unit 160 and the communication transceiver unit 180 are coupled to each other through a data bus BUS. In an embodiment, the data bus BUS includes at least one of an advanced peripheral bus (APB), an advanced extensible interface (AXI) and an advanced high-performance bus (AHB).

As shown in embodiments of FIG. 1, the buffer manager includes a register 142, which is capable of temporarily storing at least one available pointer. Each of the at least one available pointer is configured to mark a start address corresponding to a packet buffer space in the buffer memory 120. The buffer manager 140 is configured to monitor an available pointer quantity in the register 142 and assign the at least one available pointer to the processing unit 160 and the communication transceiver unit 180.

As shown in FIG. 1, the register 142 currently stores four available pointers PTR1-PTR4. The available pointer PTR1 marks the start address h0000_0000 of the packet buffer space BUF1. The available pointer PTR2 marks the start address h0000_1000 of the packet buffer space BUF2. The available pointer PTR3 marks the start address h0000_2000 of the packet buffer space BUF3. The available pointer PTR4 marks the start address h0000_3000 of the packet buffer space BUF4.

In the embodiment shown in FIG. 1, it is assumed that the packet buffer spaces BUF5-BUF8 have been occupied. Therefore, the register 142 does not store any available pointer corresponding to the packet buffer spaces BUF5-BUF8.

The buffer manager 140 is configured to manage the available pointer quantity (currently equals to 4 in the register 142 in the example shown in FIG. 1) and assign the available pointers PTR1-PTR4 to functional circuits in needs, such as the processing unit 160 and the communication transceiver unit 180.

When the processing unit 160 or the communication transceiver unit 180 requests for a packet buffer space, the buffer manager obtains (e.g., pops) an available pointer from the register 142, and assigns it to the processing unit 160 or the communication transceiver unit 180. When the processing unit 160 or the communication transceiver unit 180 finishes operations relative to the packet buffer space, the buffer manager pushes the corresponding available pointer back to the register 142, so as to release the packet buffer space for following usages. Operation details about obtaining or pushing the available pointer will be discussed in following embodiments.

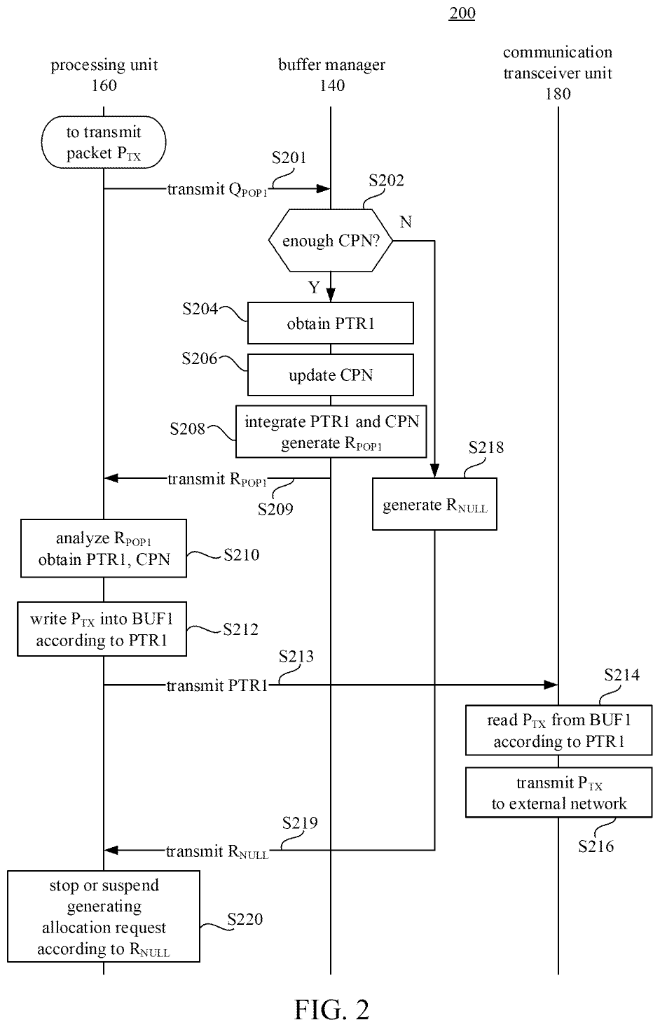

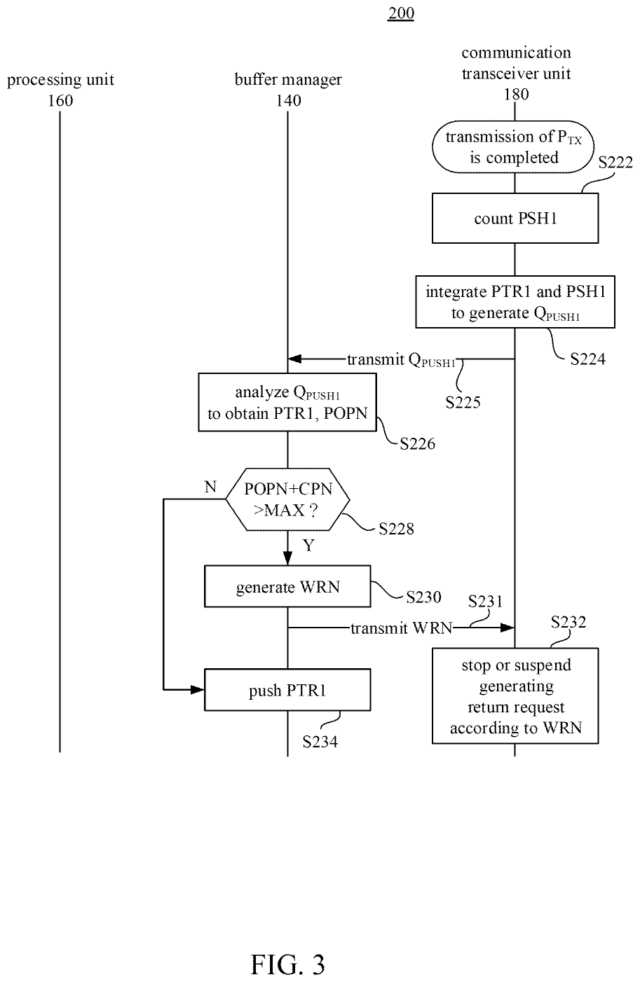

Reference is further made to FIG. 2 and FIG. 3. FIG. 2 and FIG. 3 are flow chart diagrams illustrating a control method 200 executed by the buffer manager 140 for an assignment of the available pointer during that the processing unit 160 generates the outward-transmitting packet P_{TX} and transmits the outward-transmitting packet P_{TX} through the communication transceiver unit 180.

As shown in FIG. 1 and FIG. 2, when the processing unit 160 tends to transmit the outward-transmitting packet P_{TX} to an external target, step S201 is executed by the processing unit 160 for transmitting a first allocation request Q_{POP1} to the buffer manager 140. The first allocation request Q_{POP1} is used to ask the buffer manager 140 for permission to access an available pointer corresponding to a packet buffer space in the buffer memory 120.

When the buffer manager 140 receives the first allocation request Q_{POP1}, step S202 is executed by the buffer manager 140 to check whether an available pointer quantity CPN in the register 142 is enough or not. In the example shown in FIG. 1, the register 142 currently has four available pointers PTR1-PTR4. Therefore, the buffer manager 140 determines that the available pointer quantity CPN is equal to four, and the first allocation request Q_{POP1} can be satisfied in this case. Step S204 is executed by the buffer manager 140 to obtain an available pointer from the register 142. It is assumed that the pointer obtained in this case is the available pointer PTR1 corresponding to the packet buffer space BUF1.

Afterward, step S206 is executed by the buffer manager 140 to update the available pointer quantity CPN into 3, such that the available pointer quantity CPN is able to reflect the quantity of available/accessible pointers in the register 142 in real time.

Step S208 is executed by the buffer manager 140 to integrate the first available pointer PTR1 and the available pointer quantity CPN into a first allocation response R_{POP1}.

In embodiments shown in FIG. 1, each of the packet buffer spaces BUF1-BUF8 has the same packet size, such that a gap between two adjacent start addresses of the packet buffer spaces BUF1-BUF8 is equal to h1000 expressed in hexadecimal. In other words, the gap between two adjacent start addresses is equal to 12 bits. In this case, start addresses of each two adjacent available pointers are separated by h1000 expressed in hexadecimal.

For example, the first available pointer PTR1 marks the start address, h0000_0000, of the packet buffer space BUF1. The second available pointer PTR2 marks the start address, h0000_1000, of the packet buffer space BUF2. The third available pointer PTR3 marks the start address, h0000_2000, of the packet buffer space BUF3. In this case, even though an overall address length in each available pointer is 32 bits, lower 12 bits near the least significant bit (LSB) are fixed values at h000. In other words, only higher 20 bits near the most significant bit (MSB) in each of different available pointers carry a meaningful address.

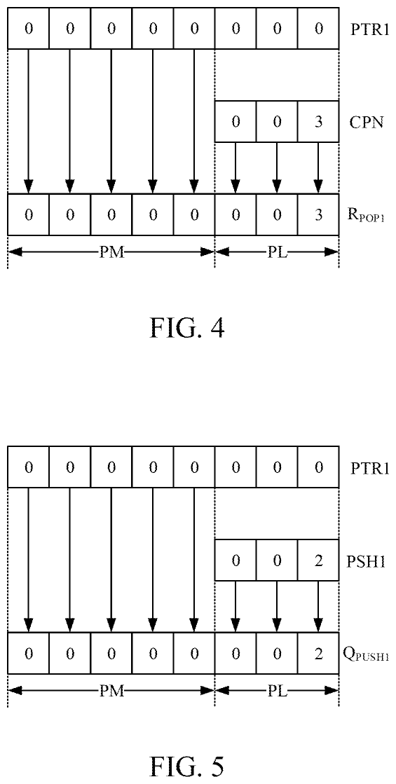

In some embodiments, the buffer manager 140 integrates and generates the first allocation response R_{POP1} by recording the available pointer quantity CPN in the lower-bits portion (i.e., the lower 12 bits near the least significant bit). Reference is further made to FIG. 4, which is a schematic diagram illustrating the integration of the first available pointer PTR1 and the available pointer quantity CPN into the first allocation response R_{POP1} according to some embodiments of the disclosure. As shown in FIG. 4, the buffer manager 140 duplicates a higher-bits portion PM of the first available pointer PTR1 as a higher-bits portion PM of the first allocation response R_{POP1}. The buffer manager 140 is configured to record the available pointer quantity CPN currently (i.e., the current available pointer quantity CPN) into a lower-bits portion PL of the first allocation response R_{POP1}, so as to generate (integrate) the first allocation response R_{POP1}. In this case, as shown in FIG. 4, the first allocation response R_{POP1} is generated as h0000_0003.

In the aforesaid example, a boundary between the higher-bits portion PM and the lower-bits portion PL in the first allocation response R_{POP1} is located between the 12^{th} bit and the 13^{th} bit, and the disclosure is not limited thereto. The boundary between the higher-bits portion PM and the lower-bits portion PL in the first allocation response R_{POP1} is decided according to a packet size of the outward-transmitting packet P_{TX}. When the packet size of the outward-transmitting packet P_{TX} is larger, the size of each of the packet buffer spaces BUF1-BUF8 is larger, and correspondingly a gap between two start addresses of two adjacent available pointers is larger. In this case, the aforesaid boundary will move closer to the most significant bit (MSB). On the other hand, when the packet size of the outward-transmitting packet P_{TX} is smaller, the size of each of the packet buffer space BUF1-BUF8s is smaller, and correspondingly the gap between two start addresses of two adjacent available pointers is smaller. In this case, the aforesaid boundary will move closer to the least significant bit (LSB).

In step S209, the buffer manager 140 transmits the first allocation response R_{POP1} to the processing unit 160, in response to the first allocation request Q_{POP1} sent from the processing unit 160. It is noticed that, in the embodiment, a length of the first allocation response R_{POP1} after integration is 32 bits, which is equal to a length of the original first available pointer PTR1.

In other words, while transmitting the first allocation response R_{POP1} from the buffer manager 140 to the processing unit 160, it can adopt the same format (i.e., with the same data length of 32 bits) as transmitting only the first available pointer PTR1. Compared with transmitting only the first available pointer PTR1 to the processing unit 160, the first allocation response R_{POP1} with the same data length is able to carry two types of information including meaningful digits of the first available pointer PTR1 and also the available pointer quantity CPN.

In step S210, the processing unit 160 is configured to analyze the first allocation response R_{POP1} to obtain the first available pointer PTR1 and the available pointer quantity CPN. The analysis operation is roughly opposite to the integration operation shown in FIG. 4. The processing unit 160 obtains the available pointer quantity CPN from the lower-bits portion PL of the first allocation response R_{POP1}. The processing unit 160 obtains the higher-bits portion PM of the first available pointer PTR1 from the higher-bits portion PM of the first allocation response R_{POP1}, and the processing unit 160 fills “000” into the lower-bits portion PL of the first available pointer PTR1.

As shown in FIG. 1 and FIG. 2, in step S212, the processing unit writes the outward-transmitting packet P_{TX} into the packet buffer space BUF1 of the buffer memory 120, according to the start address marked by the first available pointer PTR1.

In step S214, the communication transceiver unit 180 reads the outward-transmitting packet P_{TX} from the packet buffer space BUF1 of the buffer memory 120, according to the first available pointer PTR1. Afterward, in step S216, the communication transceiver unit 180 transmits the outward-transmitting packet P_{TX} to the external network 190, so as to finish an outward transmission of the outward-transmitting packet P_{TX}.

It is noticed that, during the aforesaid step S210, the processing unit 160 is able to learn (e.g., know) the available pointer quantity CPN currently of the register 142 of the buffer manager 140 and a changing trend of the available pointer quantity CPN. Accordingly, the processing unit 160 and the buffer manager 140 can negotiate about the varying trend of the available pointer quantity CPN in advance. In some applications, if the processing unit 160 learns (e.g., determines) that the available pointer quantity CPN is lower than a threshold value (e.g., there are only two available pointers left), the processing unit 160 temporarily stops transmitting other allocation request(s) or reduces a frequency of transmitting the other allocation request(s). Compared to a back-pressure flow control which prohibits the allocation request from the processing unit 160 when it completely runs out of available pointers, the embodiments in this disclosure is able to transmit the available pointer quantity CPN, such that the processing unit 160 is able to learn a current usage of available pointers in advance. It benefits the processing unit 160 in re-arranging allocation requests in the future. For example, the processing unit 160 can prioritize tasks about releasing memory space over other tasks.

The aforesaid embodiment demonstrates an example when the processing unit 160 transmits the first allocation request Q_{POP1} and the buffer manager 140 determines that the available pointer quantity CPN is sufficient. In another situation, as the control method 200 shown in FIG. 2, if there is no available pointer in the register 142 of the buffer manager 140, the buffer manager 140 determines that the available pointer quantity CPN is insufficient. In this case, step S218 is executed by the buffer manager 140 to set a lower-bits portion of an allocation response R_{NULL} to be null (or to be zero). In another embodiment, the buffer manager 140 can set the whole allocation response R_{NULL} to be null (or to be zero).

In step S219, the allocation response R_{NULL} is sent to the processing unit 160. According to the allocation response R_{NULL} set to be null (or set to be zero), the processing unit 160 is able to learn that at current stage it is not able to obtain an available pointer (and a corresponding packet buffer space) from the buffer manager 140. The processing unit 160 is able to learn that the outward-transmitting packet P_{TX} cannot be transmitted right now. The processing unit 160 can re-try again immediately or wait for a certain time period before re-submitting the allocation request. In an embodiment, when the processing unit 160 receives the allocation response R_{NULL}, step S220 is executed such that the processing unit 160 temporarily stops transmitting other allocation request(s) or reduces a frequency of transmitting the other allocation request(s).

It is noticed that, in the aforesaid steps, the control method 200 does not adjust a voltage level of a ready signal (e.g., PREADY signal) on the data bus BUS. In this embodiment, the processing unit 160 is able to re-submit another allocation request again right after a previous allocation request is denied. In other words, the control method 200 does not force the processing unit 160 or the communication transceiver unit 180 to stop transmissions and wait until the ready signal (e.g., PREADY signal) resumes to a completion level. In this case, even when a packet takes a longer time for a transmission, the control method 200 can avoid a head of line blocking problem caused by the packet.

Afterward, when the communication transceiver unit 180 completes the transmission task of the outward-transmitting packet P_{TX}, the communication transceiver unit 180 is configured to return the first available pointer PTR1 (which is currently occupied) back to the buffer manager 140. Details of returning the first available pointer PTR1 can be referred to FIG. 3. As shown in FIG. 1 and FIG. 3, when the communication transceiver unit 180 completes the transmission task of the outward-transmitting packet P_{TX}, the communication transceiver unit 180 executes step S222 to count a pending return pointer quantity PSH1.

In practical applications, the processing unit 160 and the communication transceiver unit 180 may adopt parallel processing. During a period of time, the communication transceiver unit 180 may respectively perform multiple transmission/reception tasks, and these transmission/reception tasks may be completed at different times according to their priorities and transmission conditions. The pending return pointer quantity PSH1 is configured to indicate a total amount of pointers which are currently occupied by the communication transceiver unit 180 and to be returned later after packet transmissions. For example, if the communication transceiver unit 180 still has two transmission tasks in progress, the pending return pointer quantity PSH1 is set as 2.

In step S224, the communication transceiver unit 180 integrates the first available pointer PTR1 (corresponding to the completed transmission task) and the pending return pointer quantity PSH1 into a first return request Q_{PUSH1}. Reference is further made to FIG. 5, which is a schematic diagram illustrating the integration of the first available pointer PTR1 and the pending return pointer quantity PSH1 into the first return request Q_{PUSH1} according to some embodiments of the disclosure. The communication transceiver unit 180 is configured to duplicate the higher-bits portion PM of the first available pointer PTR1 as a higher-bits portion PM of the first return request Q_{PUSH1}, and the communication transceiver unit 180 is configured to record the pending return pointer quantity PSH1 currently (i.e., the current pending return pointer quantity PSH1) into a lower-bits portion PL of the first return request Q_{PUSH1}, so as to generate (integrate into) the first return request Q_{PUSH1}.

As discussed in the aforesaid embodiments, 12 bits adjacent to the least significant bit (LSB) of the first available pointer PTR1 are fixed values. In this embodiment, the communication transceiver unit 180 records the pending return pointer quantity PSH1 in the lower-bits portion PL of the first return request Q_{PUSH1}, and it will not affect the transmission of the first available pointer PTR1. Similar to the aforesaid first allocation response R_{POP1}, the first return request Q_{PUSH1} in the same data length (e.g., the same as the original length of the whole first available pointer PTR1) is able to carry two types of information including the meaningful digits of the first available pointer PTR1 and also the pending return pointer quantity PSH1. In step S225, the communication transceiver unit 180 transmits the first return request Q_{PUSH1} to the buffer manager 140.

In step S226, the buffer manager 140 obtains (or extracts) the pending return pointer quantity PSH1 according to the lower-bits portion PL of the first return request Q_{PUSH1}, and obtains (or extracts) the first available pointer PTR1 according to the higher-bits portion PM of the first return request Q_{PUSH1}. Specifically, the buffer manager 140 obtains (or extracts) the higher-bits portion PM of the first available pointer PTR1 according to the higher-bits portion PM of the first return request Q_{PUSH1} and fills “000” into the lower-bits portion PL of the first available pointer PTR1, so as to complete the first available pointer PTR1.

Afterward, the buffer manager 140 executes step S228 to determine whether a sum of the pending return pointer quantity PSH1 and the available pointer quantity CPN is greater than a maximal accommodation volume MAX of the register 142.

In practical applications, in order to reduce costs of implementing the buffer manager 140 and the register 142, the register 142 is usually disposed with a limited storage volume. In this case, the maximal accommodation volume MAX of the register 142 can be less than a total amount of the packet buffer spaces in the buffer memory 120. When the processing unit 160 or the communication transceiver unit 180 returns a lot of available pointers in a short period, these returned available pointers may overflow and exceed the maximal accommodation volume MAX of the register 142. In this case, these overflowed pointers may be lost, and the electronic apparatus 100 is not able to utilize/access some packet buffer spaces in the buffer memory 120 corresponding to these lost pointers.

In this embodiment, the buffer manager 140 is able to detect/predict an overflowing of the pointers in advance based on the sum of the pending return pointer quantity PSH1 and the available pointer quantity CPN during step S228. In response to that the sum is detected to be greater than the maximal accommodation volume MAX, step S230 is executed to generate a warning signal WRN. In step S231, the buffer manager 140 transmits the warning signal WRN to the communication transceiver unit 180. In step S232, the communication transceiver unit 180 temporarily stops or postpones generating other return request(s) according to the warning signal WRN. In this case, the communication transceiver unit 180 will not return available pointers to the buffer manager 140 intensively, and it can prevent the available pointers from overflowing and exceeding the maximal accommodation volume MAX.

On the other hand, if the sum of the pending return pointer quantity PSH1 and the available pointer quantity CPN is not greater than the maximal accommodation volume MAX, step S234 is executed. The buffer manager 140 pushes the first available pointer PTR1 back to the register 142, so as to return the first available pointer PTR1 and release the corresponding packet buffer space BUF1. After the first available pointer PTR1 is returned, the first available pointer PTR1 can be utilized again for processing other task(s).

The aforesaid control method 200 shown in FIG. 2 and FIG. 3 describes a process in which the processing unit 160 generates the outward-transmitting packet P_{TX} and transmits the outward-transmitting packet P_{TX} through the communication transceiver unit 180. The disclosure is not limited to the outward-transmitting packet PTX. In facts, when the communication transceiver unit 180 receives a packet and transmits the packet inward, a similar control method can be adopted to process this inward-transmitting packet.

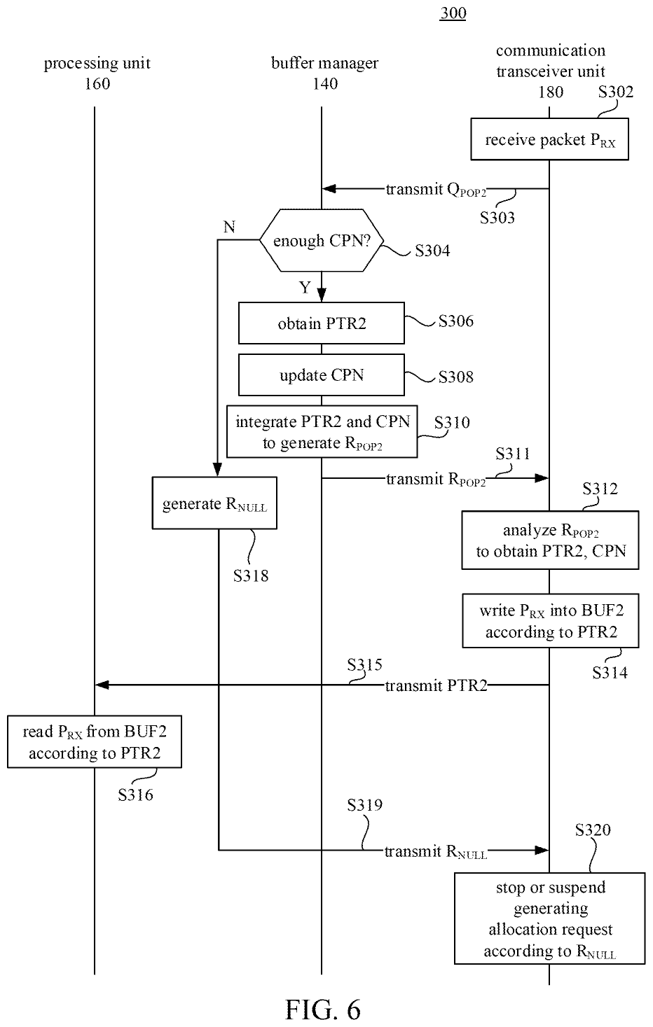

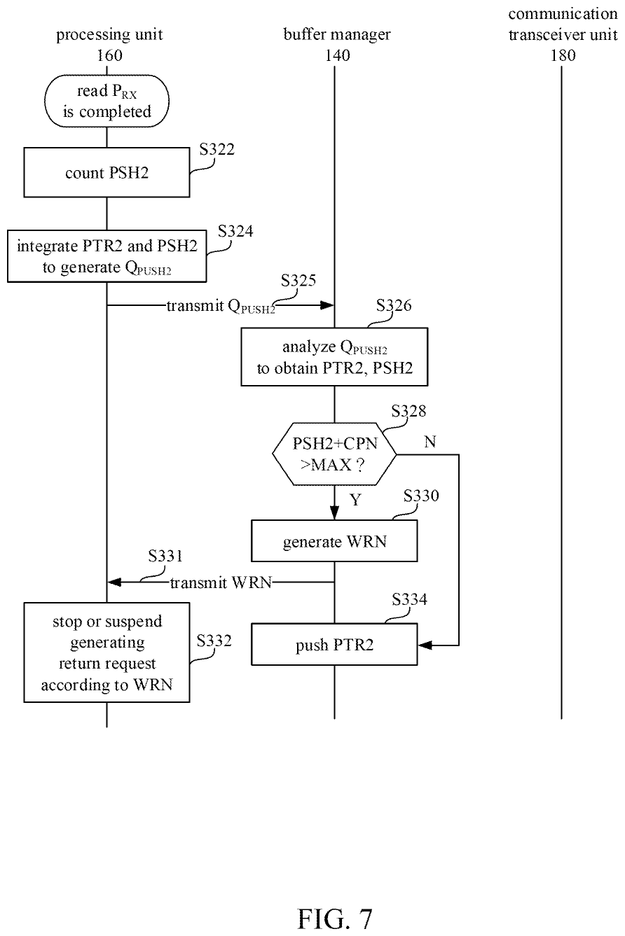

FIG. 6 and FIG. 7 are flow chart diagrams illustrating a control method 300 executed by the buffer manager 140 for an assignment of the available pointer during that the communication transceiver unit 180 receives the inward-transmitting packet P_{RX} and transmits the inward-transmitting packet P_{RX} to the processing unit 160.

As shown in FIG. 1 and FIG. 6, in step S302, the communication transceiver unit 180 receives the inward-transmitting packet P_{RX} from the external network 190. In step S303, the communication transceiver unit 180 transmits a second allocation request Q_{POP2} to the buffer manager 140.

When the buffer manager 140 receives the second allocation request Q_{POP2}, step S304 is executed to check whether the available pointer quantity CPN within the register 142 is enough or not. It is assumed that the first available pointer PTR1 is currently occupied and not returned yet, and the available pointer quantity CPN equals to 2.

In this case, the buffer manager 140 determines that the available pointer quantity CPN is currently enough, and step S306 is executed. The buffer manager 140 is configured to obtain the second available pointer PTR2 from the register 142. Step S308 is executed to update the available pointer quantity CPN.

Afterward, step S310 is executed by the buffer manager 140 to integrate a higher-bits portion PM of the second available pointer PTR2 and the available pointer quantity CPN into a second allocation response R_{POP2}. In step S310, details of the integration of the higher-bits portion PM of the second available pointer PTR2 and the available pointer quantity CPN into the second allocation response R_{POP2} is similar to step S208 in FIG. 2 and also similar to the integration of the higher-bits portion PM of the first available pointer PTR1 and the available pointer quantity CPN into the second allocation response R_{POP1} shown in FIG. 4, and the details of the integration can be referred to the aforesaid embodiments and not repeated here.

The buffer manager 140 executes step S311 to transmit the second allocation response R_{POP2} to the communication transceiver unit 180. The communication transceiver unit 180 executes step S312 to obtain (or extract) the second available pointer PTR2 and the packet buffer space BUF2 in the buffer memory 120 corresponding to the second available pointer PTR2 according to the higher-bits portion PM of the second allocation response R_{POP2}. The communication transceiver unit 180 executes step S314 to write the inward-transmitting packet P_{RX} into the packet buffer space BUF2.

The communication transceiver unit 180 executes step S315 to transmit the second available pointer PTR2 to the processing unit 160. In step S316, the processing unit 160 is able to read the inward-transmitting packet P_{RX} from the packet buffer space BUF2 according to the second available pointer PTR2.

In step S312, the communication transceiver unit 180 is able to learn the available pointer quantity CPN currently of the register 142 of the buffer manager 140 and also learn a varying trend of the available pointer quantity CPN. Accordingly, the communication transceiver unit 180 and the buffer manager 140 can negotiate about the changing trend of the available pointer quantity CPN in advance. In some applications, if the communication transceiver unit 180 learns that the available pointer quantity CPN is lower than a threshold value (e.g., there are less than two available pointers left), the communication transceiver unit 180 temporarily stops transmitting other allocation request(s) or reduces a frequency of transmitting the other allocation request(s). Compared to a back-pressure flow control which prohibits the allocation request from the communication transceiver unit 180 when it completely runs out of available pointers, the embodiments in this disclosure is able to transmit the available pointer quantity CPN, such that the communication transceiver unit 180 is able to learn a current usage of available pointers in advance. It benefits the communication transceiver unit 180 in re-arranging allocation requests in the future. For example, the communication transceiver unit 180 can prioritize tasks about releasing memory space over other tasks.

In another situation, if there is no available pointer in the register 142 of the buffer manager 140, the buffer manager 140 determines that the available pointer quantity CPN is insufficient, as shown in the control method 300 in FIG. 6. In this case, step S318 is executed by the buffer manager 140 to set a lower-bits portion of an allocation response R_{NULL} to be null (or to be zero). In another embodiment, the buffer manager 140 can set the whole allocation response R_{NULL} to be null (or to be zero).

In step S319, the allocation response R_{NULL} is sent to the communication transceiver unit 180. According to the allocation response R_{NULL} set to be null (or to be zero), the communication transceiver unit 180 is able to learn that at current stage it is not able to obtain an available pointer (and a corresponding packet buffer space) from the buffer manager 140. The communication transceiver unit 180 is able to learn that the inward-transmitting packet P_{RX} cannot be transmitted to the processing unit 160 right now. The communication transceiver unit 180 can re-try again immediately or wait for a certain time period before re-submitting the allocation request. In an embodiment, when the communication transceiver unit 180 receives the allocation response R_{NULL}, step S320 is executed such that the communication transceiver unit 180 temporarily stops transmitting other allocation request(s) or reduces a frequency of transmitting the other allocation request(s).

Afterward, when the processing unit 160 completes a reading task of the inward-transmitting packet P_{RX}, the processing unit 160 is configured to return the second available pointer PTR2 (which is currently occupied) back to the buffer manager 140. Details of returning the second available pointer PTR2 can be referred to FIG. 7. As shown in FIG. 1 and FIG. 7, when the processing unit 160 completes the reading task of the inward-transmitting packet P_{RX}, the processing unit 160 executes step S322 to count a pending return pointer quantity PSH2.

In practical applications, the processing unit 160 and the communication transceiver unit 180 may adopt parallel processing. During a period of time, the processing unit 160 may respectively perform multiple reading/writing tasks, and these reading/writing tasks may be completed at different times according to their priorities and transmission conditions. The pending return pointer quantity PSH2 is configured to indicate a total amount of pointers which are currently occupied by the processing unit 160 for the reading tasks and to be returned later. For example, if the processing unit 160 still has four inward-transmitting packets in progress, the pending return pointer quantity PSH2 is set as 4.

In step S324, the processing unit 160 integrates the second available pointer PTR2 (corresponding to the completed reading task) and the pending return pointer quantity PSH2 into a second return request Q_{PUSH2}. Details about how to integrate the second available pointer PTR2 and the pending return pointer quantity PSH2 into the second return request Q_{PUSH2} are similar to manners of integrating the first available pointer PTR1 and the pending return pointer quantity PSH1 into the first return request Q_{PUSH1} as discussed in FIG. 5, and not repeated here again.

The processing unit 160 is configured to duplicate a higher-bits portion PM of the second available pointer PTR2 as a higher-bits portion PM of the second return request Q_{PUSH2}, and the processing unit 160 is configured to record the pending return pointer quantity PSH2 currently into a lower-bits portion PL of the second return request Q_{PUSH2}, so as to generate (integrate into) the second return request Q_{PUSH2}.

In step S326, the buffer manager 140 obtains (or extracts) the pending return pointer quantity PSH2 according to the lower-bits portion PL of the second return request Q_{PUSH2}, and obtains (or extracts) the second available pointer PTR2 according to the higher-bits portion PM of the second return request Q_{PUSH2}.

Afterward, the buffer manager 140 executes step S328 to determine whether a sum of the pending return pointer quantity PSH2 and the available pointer quantity CPN is greater than the maximal accommodation volume MAX of the register 142. In some embodiments, the control method 200 shown in FIG. 2 and FIG. 3 and the control method 300 shown in FIG. 6 and FIG. 7 can be executed in parallel, and step S328 in the case can be executed to determine whether a sum of the pending return pointer quantity PSH1, the pending return pointer quantity PSH2 and the available pointer quantity CPN is greater than the maximal accommodation volume MAX of the register 142.

In this embodiment, the buffer manager 140 is able to detect/predict an overflowing of the pointers in advance based on the sum of the pending return pointer quantity PSH2 and the available pointer quantity CPN during step S328. In response to that the sum is detected to be greater than the maximal accommodation volume MAX, step S330 is executed to generate the warning signal WRN. In step S331, the buffer manager 140 transmits the warning signal WRN to the processing unit 160 (in some embodiments, the warning signal WRN can be transmitted to the communication transceiver unit 180 as well at the same time). In step S332, the processing unit 160 temporarily stops or postpones generating other return request(s) according to the warning signal WRN. In this case, the processing unit 160 will not return available pointers to the buffer manager 140 intensively, and it can prevent the available pointers from overflowing and exceeding the maximal accommodation volume MAX.

On the other hand, if the sum of the pending return pointer quantity PSH2 and the available pointer quantity CPN is not greater than the maximal accommodation volume MAX, step S334 is executed. The buffer manager 140 pushes the second available pointer PTR2 back to the register 142, so as to return the second available pointer PTR2 and release the corresponding packet buffer space BUF2. After the second available pointer PTR2 is returned, the second available pointer PTR2 can be utilized again for processing other task(s).

Although the present invention has been described in considerable detail with reference to certain embodiments thereof, other embodiments are possible. Therefore, the spirit and scope of the appended claims should not be limited to the description of the embodiments contained herein.

What is claimed is:

1. An electronic apparatus, comprising:
a processing unit;
a buffer memory, having a plurality of packet buffer spaces, wherein each of the packet buffer spaces is aligned to a packet size; and
a buffer manager, comprising a register for temporarily storing at least one available pointer, wherein each of the at least one available pointer is configured to mark a start address corresponding to a packet buffer space in the buffer memory, the buffer manager is configured to monitor an available pointer quantity and assign the at least one available pointer to the processing unit,
wherein in response to that the processing unit transmits a first allocation request to the buffer manager and the available pointer quantity is sufficient, the buffer manager is configured to obtain a first available pointer from the register, to update the available pointer quantity, the buffer manager is configured to integrate the first available pointer and the available pointer quantity into a first allocation response and transmit the first allocation response to the processing unit.

2. The electronic apparatus of claim 1, wherein the buffer manager is configured to duplicate a higher-bits portion of the first available pointer as a higher-bits portion of the first allocation response, and the buffer manager is configured to record the available pointer quantity currently into a lower-bits portion of the first allocation response, so as to generate the first allocation response.

3. The electronic apparatus of claim 2, wherein the processing unit is configured to obtain the available pointer quantity according to the lower-bits portion of the first allocation response,
in response to that the available pointer quantity is lower than a threshold value, the processing unit temporarily stops transmitting another allocation request or reduces a frequency of transmitting the another allocation request.

4. The electronic apparatus of claim 2, wherein the processing unit is configured to obtain the first available pointer and a first packet buffer space in the buffer memory corresponding to the first available pointer according to the higher-bits portion of the first allocation response, the processing unit is configured to write an outward-transmitting packet into the first packet buffer space.

5. The electronic apparatus of claim 4, further comprising:
a communication transceiver unit, configured to read the outward-transmitting packet from the first packet buffer space and transmit the outward-transmitting packet to an external network,
wherein in response to that the communication transceiver unit completes transmission of the outward-transmitting packet, the communication transceiver unit transmits a first return request to the buffer manager for returning the first available pointer, the buffer manager is configured to push the first available pointer into the register according to the first return request.

6. The electronic apparatus of claim 5, wherein the communication transceiver unit is configured to count a pending return pointer quantity, to integrate the first available pointer and the pending return pointer quantity into the first return request and transmit the first return request to the buffer manager, wherein the communication transceiver unit is configured to duplicate the higher-bits portion of the first available pointer as a higher-bits portion of the first return request, and the communication transceiver unit is configured to record the pending return pointer quantity currently into a lower-bits portion of the first return request, so as to generate the first return request.

7. The electronic apparatus of claim 6, wherein the buffer manager is configured to obtain the pending return pointer quantity according to the lower-bits portion of the first return request,
in response to that a sum of the pending return pointer quantity and the available pointer quantity is greater than a maximal accommodation volume of the register, the buffer manager is configured to transmit a warning signal to the communication transceiver unit.

8. The electronic apparatus of claim 1, wherein in response to that the processing unit transmits the first allocation request and the available pointer quantity is insufficient, the buffer manager is configured to set a lower-bits portion of the first allocation response to be null or zero and transmit the first allocation response to the processing unit.

9. The electronic apparatus of claim 1, further comprising:
a communication transceiver unit, configured to receive an inward-transmitting packet from an external network,
wherein in response to that the communication transceiver unit transmits a second allocation request to the buffer manager and the available pointer quantity is sufficient, the buffer manager is configured to obtain a second available pointer from the register and update the available pointer quantity, the buffer manager is configured to integrate a higher-bits portion of the second available pointer and the available pointer quantity into a second allocation response and transmit the second allocation response to the communication transceiver unit.

10. The electronic apparatus of claim 9, wherein the communication transceiver unit is configured to obtain the second available pointer and a second packet buffer space in the buffer memory corresponding to the second available pointer according to the higher-bits portion of the second allocation response, the communication transceiver unit is configured to write the inward-transmitting packet into the second packet buffer space.

11. The electronic apparatus of claim 10, wherein the processing unit is configured to read the inward-transmitting packet from the second packet buffer space,
in response to that the processing unit completes reading the inward-transmitting packet, the processing unit transmits a second return request to the buffer manager for returning the second available pointer, the buffer manager is configured to push the second available pointer into the register according to the second return request.

12. The electronic apparatus of claim 11, wherein the processing unit is configured to count a pending return pointer quantity, the processing unit is configured to integrate the second available pointer and the pending return pointer quantity into the second return request and transmit the second return request to the buffer manager, wherein the processing unit is configured to duplicate the higher-bits portion of the second available pointer as a higher-bits portion of the second return request, and the processing unit is configured to record the pending return pointer quantity currently into a lower-bits portion of the second return request, to generate the second return request.

13. An electronic apparatus, comprising:
a processing unit;
a buffer memory, having a plurality of packet buffer spaces, wherein each of the packet buffer spaces is aligned to a packet size; and
a buffer manager, comprising a register for temporarily storing at least one available pointer, wherein each of the at least one available pointer is configured to mark a start address corresponding to a packet buffer space in the buffer memory, the buffer manager is configured to monitor an available pointer quantity and assign the at least one available pointer to the processing unit,
wherein the processing unit is configured to count a pending return pointer quantity, to integrate a first available pointer and the pending return pointer quantity into a return request, and to transmit the return request to the buffer manager,
in response to that the buffer manager receives the return request, the buffer manager is configured to push the first available pointer into the register according to the return request and update the available pointer quantity.

14. The electronic apparatus of claim 13, wherein in response to that the buffer manager receives the return request, the buffer manager is configured to check whether a sum of the pending return pointer quantity and the available pointer quantity is greater than a maximal accommodation volume of the register,
in response to that the sum is greater than the maximal accommodation volume, the buffer manager transmits a warning signal to the processing unit.

15. A control method, comprising:
transmitting a first allocation request from a processing unit to a buffer manager;
determining by the buffer manager whether an available pointer quantity in a register is sufficient or not;
in response to that the available pointer quantity is sufficient, obtaining a first available pointer from the register by the buffer manager according to the first allocation request, the first available pointer being configured to mark a start address of a packet buffer space;
updating the available pointer quantity within the register by the buffer manager;
integrating the first available pointer and the available pointer quantity by the buffer manager for generating a first allocation response; and
transmitting the first allocation response to the processing unit by the buffer manager.

16. The control method of claim 15, wherein step of generating the first allocation response comprises:
duplicating a higher-bits portion of the first available pointer as a higher-bits portion of the first allocation response; and
recording the available pointer quantity currently into a lower-bits portion of the first allocation response, for generating the first allocation response.

17. The control method of claim 16, further comprising:
obtaining the available pointer quantity by the processing unit according to the lower-bits portion of the first allocation response received by the processing unit; and
in response to that the available pointer quantity is lower than a threshold value, temporarily stopping transmitting another allocation request or reducing a frequency of transmitting the another allocation request by the processing unit.

18. The control method of claim 16, further comprising:
obtaining the first available pointer and a first packet buffer space in a buffer memory corresponding to the first available pointer according to the higher-bits portion of the first allocation response by the processing unit; and
writing an outward-transmitting packet into the first packet buffer space by the processing unit.

19. The control method of claim 15, further comprising:
counting a pending return pointer quantity by a communication transceiver unit, wherein the communication transceiver unit is configured to integrate the first available pointer and the pending return pointer quantity into a first return request;
transmitting the first return request from the communication transceiver unit to the buffer manager; and
pushing the first available pointer into the register by the buffer manager according to the first return request.

20. The control method of claim 15, further comprising:
in response to that the available pointer quantity is insufficient, setting a lower-bits portion of the first allocation response to be null or zero by the buffer manager, and transmitting the first allocation response by the buffer manager to the processing unit.
